(19) United States
(12) Patent Application Publication
(10) Pub. No.: US 2010/0151203 A1
(43) Pub. Date: Jun. 17, 2010

(54) Long-term Impact and Puncture Resistant Corner-edge Protector with Flex Notch for Flexible Application

(76) Inventors: Steven Gregory Good, Austin, TX (US); David Demarco, Austin, TX (US)

Correspondence Address: WILSON DANIEL SWAYZE, JR., 3804 CLEARWATER CT., PLANO, TX, 75025, US

(21) Appl. No.: 12/639,807

(22) Filed: Dec. 16, 2009

Related U.S. Application Data
(60) Provisional application No. 61/201,894, filed on Dec. 16, 2008.

(51) Int. Cl. B32B 3/00; B32B 1/00

(52) U.S. Cl. 428/156; 428/174

(57) ABSTRACT

A protective cover to protect a wall surface may include a front surface, a top and bottom surface connected to the front surface, a side surface connected to the front surface, top surface and the bottom surface, and a back surface connected to the side surface and the top and bottom surface. The back surface may include a first section and a second section connected to the first section, and the angle between the first section and the second section may be selectable and adjustable. The side surface may include a curved surface and the first and second sections may be defined by a notch. The notch may be V-shaped.

### PRIORITY

The present invention claims priority under 35 USC section 119 and based upon a provisional application with a Ser. No. 61/201,894 which was filed on Dec. 16, 2008.

### FIELD OF THE INVENTION

The present invention relates to a protective cover and more particularly to a protective cover that can protect wall surfaces.

### BACKGROUND

Wall surfaces in hallways are frequently exposed to impact forces and other abuse. This is particularly true in hospitals or other such heavily trafficked buildings where damage to the walls or wall corners may result in the ordinary use of the building as a result of the careless use of carts, patient moving vehicles, and movement of furniture and/or equipment. An impact or scrapping force on a wall may, for example, chip or break a ceramic tile, or dent or otherwise cause deterioration of a plaster wall.

In order to prevent damage to the wall surfaces of public buildings, bumpers or rails of various types have been mounted on the walls and wall corners. Frequently, such protective elements are unsightly. In order to be effective and prevent damage to the wall, the bumpers or rails must be capable of absorbing the impact forces while transmitting a minimal amount of such forces to the supporting wall structure.

Not all wall surfaces are flat or connect at 90°. Therefore, there is a need for a protective cover for wall surfaces which may be joined at an angled relationship which may be greater than 90°.

In hospitals and other healthcare facilities, it is important and sometimes required to maintain the physical building in such a way that germs, bacteria, viruses and other harmful agents are minimized or eliminated. One place where these harmful agents could be collected is protective covers which have a noncontinuous surface. The noncontinuous surface may be due to breaks or cracks in the material due to weakness or age or may be induced in order to mount the protective cover in the healthcare facility. One example, maybe that the protective cover includes aperture for a mounting device such as a screw, bolts or other mounting devices. The harmful agents can gather in these cracks or apertures and spread the disease to the inhabitants of the physical facility. These health care facilities may be subject to inspection in order to eliminate the spread of the disease. Any of the above noted defects may result in the requirement that the protective cover be replaced which of course would involve additional expense and perhaps a reinspection. Him and him

### SUMMARY

A protective cover to protect a wall surface may include a front surface, a top and bottom surface connected to the front surface, a side surface connected to the front surface, top surface and the bottom surface, and a back surface connected to the side surface and the top and bottom surface.

The back surface may include a first section and a second section connected to the first section, and the angle between the first section and the second section may be selectable and adjustable.

The side surface may include a curved surface and the first and second sections may be defined by a notch.

The notch may be V-shaped.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the protective cover of the present invention;

FIG. 2 illustrates a front view of the protective cover of the present invention;

FIG. 3 illustrates a perspective view of the protective cover of the present invention.

### DETAILED DESCRIPTION

The present invention includes a protective cover 100 which may include a continuous surface on both the exterior and interior side of the protective cover and may include a integral protective cover 100 (a one-piece design him). As a consequence, the protective cover 100 is made from resilient but flexible material such as near 100% recycled vinyl that may be reinforced for strength and durability. This material may insure green compliance. The protective cover 100 resistant to cracking, punctures and staining and allows for custom fitting on odd angle corners. The use of two-sided tape or other appropriate device eliminates the needs for apertures to be introduced into the protective cover 100. The protective cover 100 may be bacteria, mildew, virus, and other harmful agents resilient. The protective cover provides protection where walls come together and may be subject to hard impact from mobile rolling equipment such as beds, testing-lab equipment, supply carts, patient wheelchairs or other such objects. The present invention may include a flex notch which may provide sufficient flexibility so that the flexible cover 100 can be configured to cooperate with a substantially any angle formed by intersecting walls.

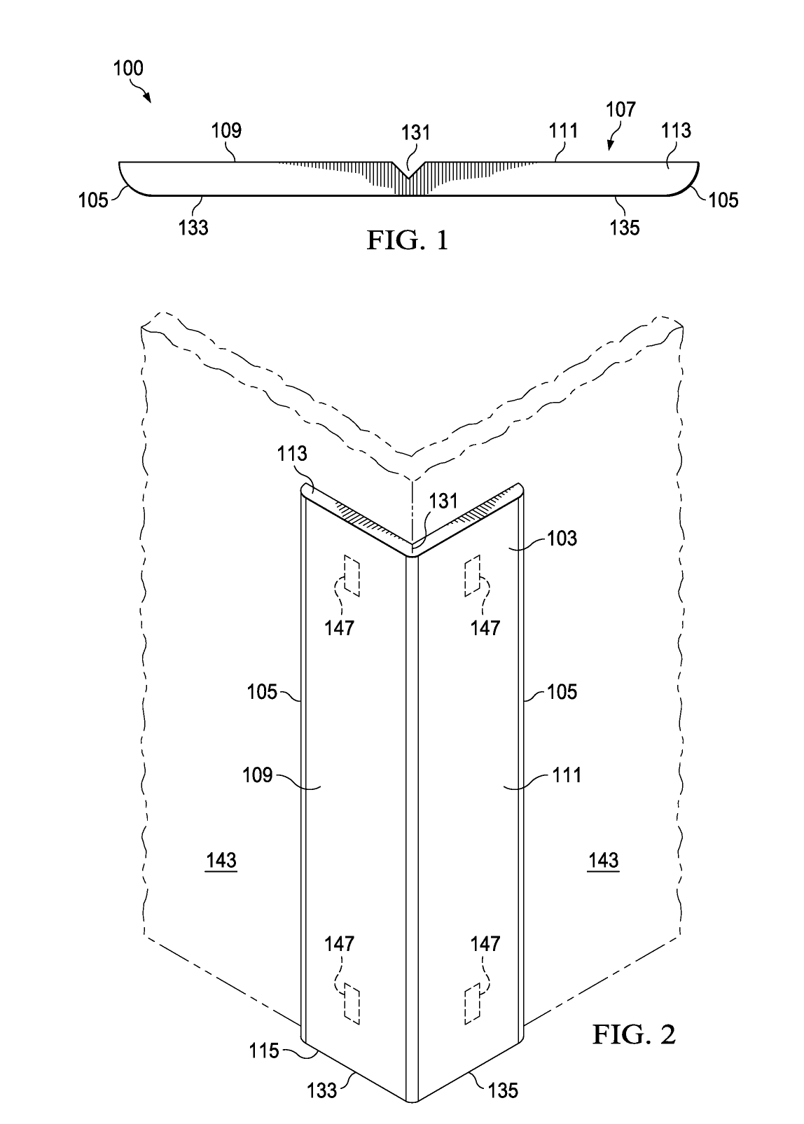

FIG. 1 illustrates a top view to illustrate the profile of the protective cover 100 which may include a front surface 109 which may be substantially rectangular, oval or other appropriate shape and which may be substantially planar. The protective cover 100 may include a first panel 133 and a second panel 135 which may pivot or fold with respect to the first panel 113. The front surface 109 may be connected to a top surface 113 and may be connected to a bottom surface 115. Furthermore, the front surface 109 may be connected to a pair of opposing curved side surfaces 117, and the opposing curved side surfaces 107 may be connected to a back surface 107 which may be connected to the top surface 113 and the bottom surface 115. The back surface 107 may include a first surface section 109 and a second surface section 111 which may be separated by a notch 131 which may be V-shaped and which may extend between top surface 113 and the bottom surface 115 to define the first panel 113 and the second panel 135 and which may extend substantially vertically. The notch 131 may be V-shaped or other appropriate shape in order to allow the first panel 133 to pivot or fold with respect to the second panel 135.

FIG. 2 illustrates a front/perspective view to illustrate the profile of the protective cover 100 which may include a front surface 109 which may be substantially rectangular, oval or other appropriate shape and which may be substantially planar. FIG. 2 illustrates a first support surface 141 and a second support surface 143 which may be connected, and FIG. 2 illustrates that the first panel 133 may be connected to the first support surface 141 (which may be a wall) and that the second panel 135 may be connected to the second support surface 143 by fasteners 147 which may be double-sided tape which may include adhesive on both the front and back sides of the tape. The first support surface 141 may join the second support surface 143 at an angle which may not be 90° in which case the angle between the first panel 133 and the second panel 135 can be selectively pivoted or fold at an angle which corresponds to the angle between the first support surface 141 and a second support surface 143. The protective cover 100 may include a first panel 133 and a second panel 135 which may pivot or fold with respect to the first panel 113. The front surface 109 may be connected to a top surface 113 and may be connected to a bottom surface 115. Furthermore, the front surface 109 may be connected to a pair of opposing curved side surfaces 117, and the opposing curved side surfaces 107 may be connected to a back surface 107 which may be connected to the top surface 113 and the bottom surface 115. The back surface 107 may include a first surface section 109 and a second surface section 111 which may be separated by a notch 131 which may be V-shaped and which may extend between top surface 113 and the bottom surface 115 to define the first panel 113 and the second panel 135. The notch 131 may be V-shaped or other appropriate shape in order to allow the first panel 133 to pivot or fold with respect to the second panel 135.

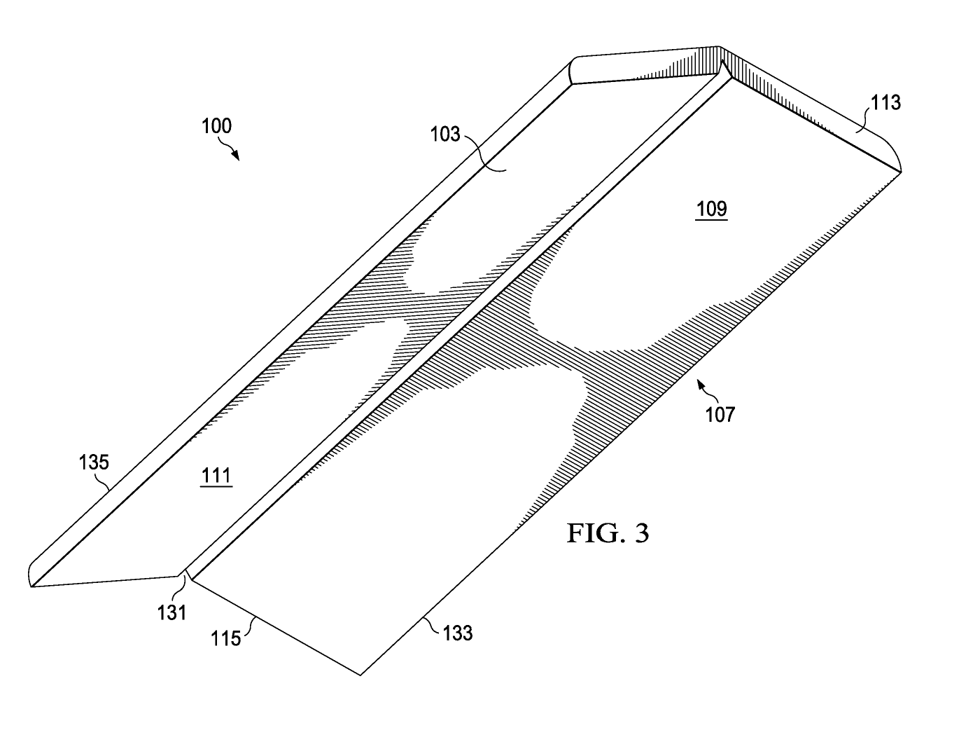

FIG. 3 illustrates an orthographic view to illustrate the protective cover 100 which may include a front surface 109 which may be substantially rectangular, oval or other appropriate shape and which may be substantially planar. FIG. 3 illustrates that the first panel 113 and a second panel 115 has been pivoted or folded to an angle which is substantially greater than 90° in order to accommodate a selected angle so that the first panel 113 and the second panel 115 be attached to the first and second support surface (not shown in FIG. 3). The protective cover 100 may include a first panel 133 and a second panel 135 which may pivot or fold with respect to the first panel 113. The front surface 109 may be connected to a top surface 113 and may be connected to a bottom surface 115. Furthermore, the front surface 109 may be connected to a pair of opposing curved side surfaces 117, and the opposing curved side surfaces 107 may be connected to a back surface 107 which may be connected to the top surface 113 and the bottom surface 115. The back surface 107 may include a first surface section 109 and a second surface section 111 which may be separated by a notch 131 which may be V-shaped and which may extend between top surface 113 and the bottom surface 115 to define the first panel 113 and the second panel 135. The notch 131 may be V-shaped or other appropriate shape in order to allow the first panel 133 to pivot or fold with respect to the second panel 135. The protective cover 100 may be formed from environmentally friendly and chemical resilient materials and may be formed from recycled vinyl that may be reinforced for strength and durability. The protective cover 100 may be used in interior applications and exterior applications.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A protective cover to protect a wall surface, comprising;
a front surface;
a top and bottom surface connected to the front surface;
a side surface connected to the front surface, top surface and the bottom surface;
a back surface connected to the side surface and the top and bottom surface;
wherein the back surface includes a first section and a second section connected to the first section; and
wherein an angle between the first section and the second section is selectable and adjustable.

2) A protective cover to protect a wall surface as in claim 1, wherein the side surface includes a curved surface.

3) A protective cover to protect a wall surface as in claim 1, wherein the first and second sections are defined by a notch.

4) A protective cover to protect a wall surface as in claim 3, wherein the notch is V-shaped.
